(19) United States
(12) Patent Application Publication
(10) Pub. No.: US 2017/0368908 A1
(43) Pub. Date: Dec. 28, 2017

(54) AUTOMATIC VEHICLE VENTILATION AND TEMPERATURE REGULATION SYSTEM

(71) Applicant: FORD GLOBAL TECHNOLOGIES, LLC, Dearborn, MI (US)

(72) Inventors: Oscar Hernandez Cervantes, Naucalpan de Juarez (MX); Oscar Monroy Vallejo, Mexico City (MX); Luis Antonio Ocegueda Perez, Ecatepec de Morelos (MX); Tonatiuh Santana Sanchez, Ecatepec de Morelos (MX); Antonio Espiritu Santo Rincon, Atizapan de Zaragoza (MX)

(21) Appl. No.: 15/195,580

(22) Filed: Jun. 28, 2016

(51) Int. Cl. B60H 1/00; B60J 7/043; B60H 1/26; B60J 7/057

(52) U.S. Cl. CPC B60H 1/00828; B60J 7/057; B60J 7/043; B60H 1/0075; B60H 1/00778; B60H 1/00771; B60H 1/262

(57) ABSTRACT

A system for ventilating a vehicle cabin includes a powered vent, such as a window or sunroof, for opening and closing to selectively ventilate the vehicle cabin. A controller may be provided for: (1) opening the powered vent based on a pre-determined opening time; (2) controlling the powered vent to activate based on a pre-determined parking location; and/or (3) controlling the powered vent to activate based on a sunlight intensity.

### TECHNICAL FIELD

This document relates generally to the motor vehicle field and, more particularly, to an automatic vehicle ventilation and temperature regulation system.

### BACKGROUND

Sunroofs are a popular vehicle accessory, but can create issues requiring added attention for correct implementation. For instance, the forgetfulness of the operator can result in a sunroof being left in an open condition while the vehicle is parked outdoors, which can leave the vehicle prone to invasion by rain or intermeddlers. Obstructions can also block the closing of the sunroof.

In this regard, proposals have been made for using sensors to detect conditions such as temperature, rain, or obstructions in order to regulate sunroof operation in an automated fashion. While the resulting systems may overcome the aforementioned issues, none takes full advantage of the use of the sunroof in an open condition as a manner for providing enhanced ventilation for the vehicle when it is not in use, such as based on a particular time, location, or light intensity.

Accordingly, a need is identified for an automatic vehicle ventilation and temperature regulation system.

### SUMMARY

According to one aspect of the disclosure, a system for ventilating a vehicle cabin is disclosed. The system comprises a powered vent for opening and closing to selectively ventilate the vehicle cabin. A controller is provided for opening the powered vent based on a pre-determined opening time.

The system may further include an input for providing the pre-determined opening time. The input may be providing on a vehicle console in the vehicle cabin including the input. Alternatively or additionally, a handheld mobile computer may include the input.

In one possible embodiment, the controller is adapted to close the vent based on a sensed condition. The sensed condition may be selected from the group consisting of time, temperature of the vehicle cabin, a vehicle intrusion, or any combination thereof. The controller may also be adapted to close the vent based on a pre-determined closing time. The controller may also be adapted for controlling the vent to open at the pre-determined opening time only when a vehicle ignition is off.

According to a further aspect of the disclosure, a system for ventilating a vehicle cabin is proposed. The system comprises a vent for opening and closing to selectively ventilate the vehicle cabin. A controller is provided for controlling the vent to activate based on a parking location.

The parking location may be, for example, a secure location, such as a home location, a work location, or other location with a parking structure known to be safe. A positioning system may be provided to determine the location of the vehicle. The controller interfaces with the positioning system to determine whether the vehicle is located at the pre-determined parking location. The controller may also be adapted to close the vent based on a sensed condition, and for activating the vent only when a vehicle ignition is off.

Still a further aspect of the disclosure pertains to a system for ventilating a vehicle cabin. The system comprises a vent for opening and closing to selectively ventilate the vehicle cabin. The system further includes a controller for controlling the vent to activate based on a sunlight intensity.

In one embodiment, the system includes a light sensor arranged for sensing the sunlight intensity. A temperature sensor may also be provided for sensing a temperature, either internal or external to the vehicle cabin. The controller may be adapted to control the vent based on sunlight intensity when the sensed temperature exceeds a pre-determined value.

In the following description, several embodiments of the automated vehicle ventilation and temperature regulation system are shown and described. As it should be realized, the arrangement is capable of other, different embodiments and its several details are capable of modification in various, obvious aspects all without departing from the automated vehicle ventilation and temperature regulation system as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the disclosed automated vehicle ventilation and temperature regulation system, serve to explain certain principles thereof. In the drawing figures:

FIG. 1 is a perspective view of a vehicle including a sunroof forming a powered vent; and

FIG. 2 is a schematic diagram illustrating an automated sunroof ventilation and temperature regulation system according to the present disclosure.

Reference will now be made in detail to the present preferred embodiments of the system, examples of which are illustrated in the accompanying drawing figures.

### DETAILED DESCRIPTION

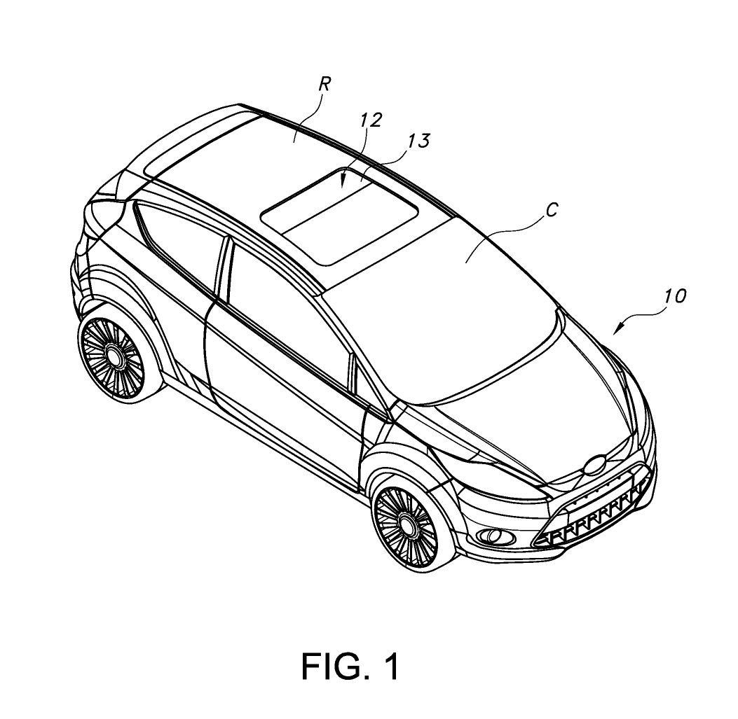

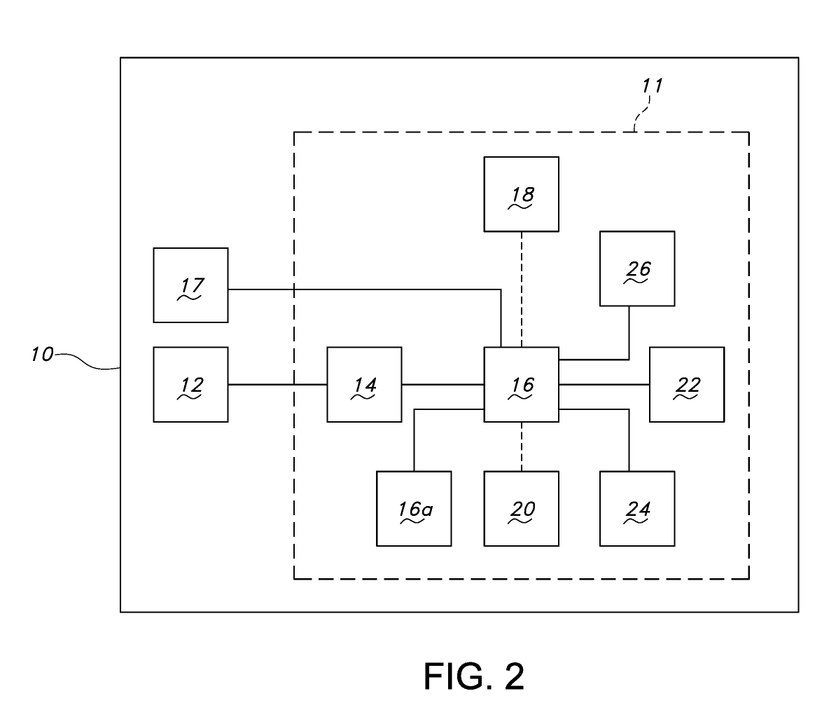

Reference is now made to FIGS. 1 and 2, which illustrate a vehicle 10 including a powered vent, such as a sunroof 12 in the vehicle roof R to expose the vehicle cabin to the ambient environment for ventilation purposes and an associated control system 11. The sunroof 12 may include a cover 13, such as a window for covering the opening in a vehicle roof R. The cover 13 is associated with an actuator, such as a motor 14, for causing it to move between an open condition where air can flow between the ambient environment into the interior of the vehicle cabin C, and a closed condition where no or minimal airflow is permitted. The open condition may be such that the opening formed in the vehicle roof is either partially or fully open, and may involve moving the cover 13 generally horizontally in alignment with the direction of travel, in a generally vertical direction (such as by pivoting), or both.

According to one aspect of the disclosure, the motor 14 may be controlled by a controller 16 for causing the activation or movement of the cover 13. The controller 16 may be adapted for controlling the movement based on a pre-determined time, such as for example a time of day. The controller 16 may receive the information regarding the pre-determined time from an input 18, such as for example an input device within the vehicle 10, such as a smart interface or touch screen on a vehicle console. Alternatively or additionally, the input 18 may be provided from a remote device, such as a portable handheld computer (e.g., a “smart” phone) running suitable application software.

In any case, based on the inputted pre-determined time, the controller 16 may cause the cover 13 to move from a closed condition to an open condition (and typically only when an ignition 17 of the vehicle 10 is off). Thus, as one example, if a vehicle operator is planning on leaving work at 5 p.m. and the vehicle 10 has been parked at a warm location, such as a closed parking structure or in direct sunlight on a warm day in a parking lot, the operator may indicate to the controller 16 that the pre-determined time is 4:30 pm. When the controller 16 determines that the pre-determined time is reached, such as by communicating with a clock 16a that either forms part of the controller 16 or is made available to it via a communication link, the motor 14 is activated to open the cover 13, thus allowing for ventilating of the vehicle cabin C.

The controller 16 may also be programmed to cause the sunroof 12 to activate at a pre-determined time following the opening at the pre-determined time. Thus, in another example, the cover 13 via motor 14 may be caused to open at the pre-determined time, such as at 4:30 p.m., and then caused to close at a later time, such as at 5:30 p.m. or a fixed period of time after opening. In this manner, the system 11 may account for the anticipated operation of the vehicle 10 with the sunroof 12 closed, yet allow for the desired ventilation to be provided in the meantime.

The system 11 may also control the sunroof 12 to cause cover 13 to assume different positions based on time. Thus, for example, the controller 16 may open the cover 13 fully at one pre-determined time, such as at 4:30 p.m. in the above example, and then cause it to partly close at a later time (again, either after the passage of a fixed amount of time, or at a particular time of day). In this manner, the desired ventilation may be achieved, followed by the partial closing prior to vehicle operation.

As an optional feature, the controller 16 may also receive information regarding whether conditions are appropriate for activating the sunroof 12. For instance, a sensor 22 may be provided for sensing whether it is raining in the ambient environment, in which case the controller 16 may override the intended opening at the pre-determined time by keeping the cover 13 closed. Alternatively, the cover 13 may be opened in a manner that avoids allowing any significant moisture to enter the vehicle cabin C, such as by being only partly opened (such as by pivoting vertically). In lieu of a rain sensor, information regarding ambient weather conditions may also be received by the controller 16 over a communications network (such as the Internet) to determine whether it is likely raining or not, and a corresponding adjustment made by controller 16.

The sensor 22 may also take different forms for providing information of interest to the controller 16. Thus, for instance, the sensor 22 may comprise an obstruction sensor for sensing that the opening in the vehicle roof R created by the open cover 13 is clear. Upon detecting an obstruction, such as the result of an intruder attempting to enter the vehicle 10 through the opening thus formed, the controller 16 may cause the cover 13 to move toward or to the closed position in an automatic fashion. In this manner, the closing may serve as a theft deterrent. The user may also be notified of such an event via a notification sent to a remote location, such as a mobile or portable computer, and thus be alerted to the need to check on the vehicle 10.

The closing may also be achieved based on detected conditions inside the vehicle 10. Thus, for example, the sensor 22 may be a sensor for sensing the internal temperature in the vehicle cabin C. The controller 16 may automatically open the cover 13 at the pre-determined time, and then keep it open until the sensed temperature in the vehicle cabin C reaches a particular state (which could be a particular pre-determined temperature level, a pre-determined reduction in temperature, or perhaps even just correspondence with the ambient temperature). The temperature level causing activation of the sunroof 12 (such as to close once open at a pre-determined time) may also be regulated by the operator using the input 18. The user may also use the input 18 to provide a desired time to reach a particular temperature, and the system 11 may adjust accordingly via controller 16.

According to another aspect of the disclosure, the system 11 may alternatively or additionally be adapted for controlling the sunroof 12 based on an indication that the vehicle 10 is located at a pre-determined parking location (which may be user-defined). The controller 16 may receive information regarding the vehicle location using a positioning system 24, such as a global positioning system (GPS). Based on being at a particular location, the cover 13 may be opened or closed.

Thus, in one example, the cover 13 may be automatically opened for exposing and thus ventilating the vehicle 10 when it is determined to be at a particular place, such as a home location. This may be determined by a user providing information via input 18 regarding the home location (or any other location at which the user desires for the system 11 to be operational to regulate the automatic opening of the sunroof 12). Then, when the positioning system 24 indicates the location of the vehicle 10 at the home location, the controller 16 may cause the sunroof 12 to open.

As can be appreciated, the parking location may be other than a home location. Thus, for example, the parking location may be a secure parking structure (such as a garage), the location of which is identified to the controller 16 by the input 18 (either by the operator or by a communications network). Again, when the positioning system 24 indicates the location of the vehicle 10 at the secure location, the controller 16 may cause the sunroof 12 to open.

Similarly, when the location is not a known or pre-determined safe parking location, the controller 16 may cause the cover 13 to automatically close. Thus, when a vehicle operator neglects or forgets to close the cover 13 after operating the vehicle 10, and the controller 16 relying on the positioning system 24 determines that the location is not a pre-determined safe one (i.e., home), the cover 13 may be automatically closed (relying on the vehicle battery when the ignition 17 is off). Of course, the feature may be toggled on or off by the operator or user using input 18, such as if there is an intention to leave the sunroof 12 open despite the detected location of the vehicle 10 corresponding to a known or pre-determined parking location.

As can be further appreciated, the system 11 according to this aspect may be operated in connection with the timing aspect noted above such that the two work in concert. For instance, if the controller 16 is scheduled to open the cover 13 at a particular time, it may check the parking location to determine if it is a pre-determined location indicated as known or safe by the vehicle operator. If not, then the controller 16 may not cause the opening to occur.

Similar logic may be applied using the sensor 22, such that the location-based opening is precluded if, for example, it is determined to be raining, or a closing may occur if, once open, rain is detected or determined to be present. Likewise, if the ambient temperature in the vehicle cabin C is at a pre-determined level considered to be desirable, then the controller 16 may not perform the opening despite having a favorable indication of location and a desire for opening according to a previous instruction by the user.

A further aspect of the disclosure pertains to a system 11 for regulating a sunroof 12 according to a sensor 26 for sensing light, and sunlight intensity in particular. This sensor 26 may be provided anywhere on the vehicle 10 exposed to light. The sensor 26 may work in connection with the above-referenced sensor 22 for sensing other conditions, such as temperature, or may be a substitute therefore (such as by using sunlight intensity as a measure of predicted temperature, or temperature change over time).

Thus, when the light sensor 26 indicates that the sunlight is about a particular luminous threshold corresponding to bright sunlight (e.g., equal to greater than 25,000 lux) for a given instant or period of time, the controller 16 may be programmed to open the cover 13 to allow for ventilation. If the ambient temperature is less than a particular value (e.g., below 32 degrees Fahrenheit), then the opening may be precluded or regulated to be only a partial opening, despite the sunlight being above the threshold value (which may be selected by the user or operator via input 18). Similarly, if the sunlight intensity is below a particular value, such as for a prolonged amount of time indicative of cloudy conditions or nighttime (and concomitant cooling), and the cover 13 is in the open condition (either as a result of a prior automatic or manual operation), the controller 16 may initiate a full or partial closing operation (possibly followed by a reversal, should conditions change).

In any or all cases, the user of the vehicle 10 may be notified of the opening or closing of the sunroof 12, including at a remote location. This may be achieved by the controller 16 issuing a signal over a communications network to a portable device, such as a handheld computer of the user or operator. The user may also be given the opportunity to override the opening and closing of the sunroof 12 prior to the event, such as for a pre-determined time. A visual or aural notification of the event may be provided at the election of the user.

While the above-described aspects of the disclosure pertain to a sunroof, it should be appreciated that these aspects may be applicable to other forms of powered vents. For example, the system 11 may work in connection with one or more windows of the vehicle. In one particular arrangement, the windows may be opened and closed in concert with the sunroof 12.

In summary, a system 11 is provided for enhancing the functionality of a powered vehicle vent, such as a sunroof 12. Opening and closing of the sunroof 12 may be done based on a pre-determined time, such as the time of day, so as to allow for ventilation of the vehicle prior to operation. Detection of the vehicle 10 being located at a pre-determined parking location known to be safe may also be used to activate the sunroof 12. Similarly, light sensing capabilities may also be provided to the system 11 to regulate the opening and closing of the sunroof 12. The features may be implemented independently or in concert to provide for a robust and reliable system that accounts for various conditions of the vehicle 10.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A system for ventilating a vehicle cabin, comprising:
a powered vent for opening and closing to selectively ventilate the vehicle cabin; and
a controller for opening the powered vent at a pre-determined opening time.

2. The system of claim 1, further including an input for providing the pre-determined opening time.

3. The system of claim 2, further including a vehicle console in the vehicle cabin including the input.

4. The system of claim 2, further including a portable or handheld computer including the input.

5. The system of claim 1, wherein the controller is adapted to close the powered vent based on a sensed condition.

6. The system of claim 5, wherein the sensed condition is selected from the group consisting of time, temperature, a vehicle intrusion, or any combination thereof.

7. The system of claim 1, wherein controller is adapted to close the powered vent at a pre-determined closing time.

8. A vehicle including the system of claim 1, and wherein the powered vent comprises a sunroof.

9. The vehicle of claim 8, and wherein the controller is adapted for controlling the powered vent to open at the opening time only when a vehicle ignition is off.

10. A system for ventilating a vehicle cabin, comprising:
a powered vent for opening and closing to selectively ventilate the vehicle cabin; and
a controller for controlling the powered vent to activate based on a parking location.

11. The system of claim 10, wherein the parking location is selected from the group consisting of a home location, a work location, or a secure parking structure.

12. The system of claim 10, further including a positioning system to determine the location of the vehicle, and wherein the controller interfaces with the positioning system to determine whether the vehicle is located at the parking location.

13. The system of claim 10, wherein the controller is adapted to close the powered vent based on a sensed condition.

14. The system of claim 13, wherein the sensed condition is selected from the group consisting of time, temperature, a vehicle intrusion, or any combination thereof.

15. A vehicle including the system of claim 10, and wherein the powered vent comprises a sunroof.

16. The vehicle of claim 15, and wherein the controller is adapted for controlling the powered vent to activate only when a vehicle ignition is off.

17. A system for ventilating a vehicle cabin, comprising:
a powered vent for opening and closing to selectively ventilate the vehicle cabin; and
a controller for controlling the powered vent to activate based on a light intensity.

18. The system according to claim 17, further including a light sensor arranged for sensing the light intensity.

19. The system of claim 18, further including a temperature sensor for sensing a temperature, wherein the controller is adapted to control the powered vent based on the light intensity when the sensed temperature exceeds a pre-determined value.

20. A vehicle including the system of claim 17, and wherein the powered vent comprises a sunroof.
